(19) United States
(12) Patent Application Publication
(10) Pub. No.: US 2020/0312084 A1
(43) Pub. Date: Oct. 1, 2020

(54) MODIFICATION OF GAMING OUTCOMES USING SYMBOL EVOLUTION

(71) Applicant: KING SHOW GAMES, INC., Minnetonka, MN (US)

(72) Inventor: Christian BRADLEY, Minneapolis, MN (US)

(21) Appl. No.: 16/827,846

(22) Filed: Mar. 24, 2020

Related U.S. Application Data
(60) Provisional application No. 62/823,023, filed on Mar. 25, 2019.

(51) Int. Cl. G07F 17/32; G07F 17/34

(52) U.S. Cl. CPC G07F 17/3213; G07F 17/3267; G07F 17/3258; G07F 17/34

(57) ABSTRACT

Systems, apparatuses and methods for enhancing player experiences by providing intra-symbol levels and symbol evolution therebetween in gaming activities and devices utilizing symbols. Embodiments involve trigger-based evolution within a symbol, thereby enabling such evolution-capable symbol to be utilized at different levels which may correspond to different outcomes, probabilities, payouts, and/or other player benefits.

### FIELD

This disclosure relates generally to games, and more particularly to systems, apparatuses and methods for providing intra-symbol levels and symbol evolution therebetween in gaming activities and devices utilizing symbols.

### BACKGROUND

Casino games such as poker, slots, and craps have long been enjoyed as a means of entertainment. Some of these games originated using traditional elements such as playing cards or dice. More recently, gaming devices have been developed to simulate and/or further enhance these games while remaining entertaining. The popularity of casino gambling with wagering continues to increase, as does recreational gambling such as non-wagering computer game gambling. Part of this popularity is due to the increased development of new types of games that are implemented, at least in part, on gaming devices.

One reason that casino games are widely developed for gaming devices is that a wide variety of games can be implemented on gaming devices, thereby providing an array of choices for players looking to gamble. For example, the graphics and sounds included in such games can be modified to reflect popular subjects, such as movies and television shows. Game play rules and types of games can also vary greatly providing many different styles of gambling. Additionally, gaming devices require minimal supervision to operate on a casino floor, or in other gambling environments. That is, as compared to traditional casino games that require a dealer, banker, stickman, pit managers, etc., gaming devices need much less employee attention to operate.

With the ability to provide new content, players have come to expect the availability of an ever wider selection of new games when visiting casinos and other gaming venues. Playing new games adds to the excitement of “gaming.” As is well known in the art and as used herein, the term “gaming” and “gaming devices” generally involves some form of wagering, and that players make wagers of value, whether actual currency or something else of value, e.g., token or credit. Wagering-type games usually provide rewards based on random chance as opposed to skill, although some skill may be an element in some types of games. Since random chance is a significant component of these games, they are sometimes referred to as “games of chance.”

The present disclosure describes systems, apparatuses and methods that facilitate new and interesting gaming experiences, and provide advantages over the prior art.

### SUMMARY

The present disclosure is directed to systems, apparatuses, computer-readable media, and/or methods that are configured to facilitate intra-symbol level evolution, where player benefits may change depending on the evolution level in which the symbol(s) is currently being played.

For example, in one embodiment, a slot game device is provided that includes a display presenting a plurality of symbol locations forming an array, a user interface, a wager input device structured to identify and validate player assets and to permit the player to play the slot game event when the player assets are provided, and a processor. The processor may be configured to evolve a symbol from one level of that symbol to another level of that symbol in response to determining that some criteria has been met, and to modify player benefits at least involving that symbol when at one level relative to that symbol at another level.

In one embodiment, a slot game apparatus is provided for enhancing slot game awards in a slot game. The slot game apparatus includes a display, a user interface including at least one user input to enable a player to initiate and participate in the slot game, and a wager input device structured to identify and validate player assets, and to permit the player to participate in the slot game when the player assets are provided. The slot game apparatus further includes a plurality of simulated reels that are each made visibly presentable via the display, and include a plurality of symbols taken from a set of symbols, where one or more of the symbols are configured as evolution-capable symbols. This embodiment of the slot game apparatus includes a processor configured to randomly present, via the display, a playable portion of the simulated reels, and to determine whether at least one criterium is met for any evolution-capable symbols presented on the playable portion of the simulated reels. In response to the processor determining that the at least one criterium is met for any of the presented evolution-capable symbols, the processor is further configured to evolve the respective ones of the presented evolution-capable symbols from a lower level to a higher level, where slot game payouts involving higher level presented evolution-capable symbols are greater than the slot game payouts involving lower level presented evolution-capable symbols.

In one embodiment of such a slot game apparatus, the criteria for upward evolving an evolution-capable symbol(s) is whether that evolution-capable symbol(s) is involved in a winning outcome. For example, in one embodiment, the processor is configured to determine whether the at least one criterium is met by determining that the respective presented evolution-capable symbols at their respective lower level are involved in winning outcomes resulting in the slot game payouts.

In another embodiment, the evolution-capable symbols that have evolved upwards may stay at that higher level for one or more additional slot games. For example, in one embodiment, the processor of the slot game apparatus is configured to provide the slot game payouts involving the higher level of the presented evolution-capable symbols for a consecutive number of the slot games. In one particular embodiment, the evolution-capable symbol may evolve still further if criteria is met, or may be demoted based on the same or other criteria. For example, in one particular embodiment, the processor is configured to return the higher level evolution-capable symbols down to the lower level evolution-capable symbols and a corresponding slot game payout if criteria does not reoccur during the consecutive number of the slot games.

In still another embodiment of such a slot game apparatus, the processor is further configured to determine whether at least one additional criterium is met for any of the higher level evolution-capable symbols presented on the playable portion of the plurality of simulated reels. In response to the processor determining that the at least one additional criterium has been met for any of the higher level presented evolution-capable symbols in such an embodiment, the processor is configured to evolve the respective presented higher level evolution-capable symbols to a next higher level, where slot game payouts involving that next higher level of the presented evolution-capable symbols are greater than the slot game payouts involving the higher level (the level prior to the “next higher level”) of the respective presented evolution-capable symbols. In one particular embodiment, the processor is configured to provide the slot game payouts involving that next higher level of the respective presented evolution-capable symbols for a consecutive number of the slot games. In still another embodiment, the processor is configured to return that next higher level evolution-capable symbol(s) down to the higher level evolution-capable symbol(s) and its corresponding lower slot game payout if the additional criteria does not reoccur during the consecutive number of the slot games.

In another embodiment of such a slot game apparatus, a plurality of the evolution-capable symbols are provided, and at least one of the plurality of evolution-capable symbols is at a different level of evolution than another evolution-capable symbol(s) during a particular one of the slot games.

In one embodiment of such a slot game apparatus, the processor is configured to cause the display to present different visual presentations of each of the respective levels of an evolution-capable symbol. In still another embodiment, the different visual presentations are intuitively associated with the particular level of that respective evolution-capable symbol; e.g. a “lowest” level might depict an acorn, a higher level might depict a sapling, and a next higher (and in some embodiments highest) level might depict a tree.

In accordance with another embodiment, a slot game apparatus is provided for enhancing slot game awards in a slot game. The slot game apparatus includes a display, a user interface including at least one user input to enable a player to initiate and participate in the slot game, and a wager input device structured to identify and validate player assets and permit the player to participate in the slot game when the player assets are provided. The slot game apparatus further includes a plurality of simulated reels, each presentable via the display and including multiple symbols from a set of symbols. The slot game apparatus further includes a processor configured to provide at least one of the symbols as an evolution-capable symbol having some number (e.g. “N”) stages ranging from a lowest stage to a highest stage, and to randomly present, via the display, a playable portion of the plurality of simulated reels. The processor is configured to determine whether the evolution-capable symbol is involved in a predetermined number of winning outcomes at a first payout level. In response to the processor determining that the evolution-capable symbol is involved in the predetermined number of winning outcomes at the first payout level, the processor is configured to evolve the evolution-capable symbol from the lowest stage to a second stage, and activate a second payout level for winning outcomes involving the evolution-capable symbol at the second stage. The processor is further configured to increase the evolution-capable symbol to a still higher stage and utilize a respectively higher payout level each time the evolution-capable symbol is involved in the predetermined number of winning outcomes until reaching the highest stage, and decrease the evolution-capable symbol to a lower stage and utilize a respectively lower payout level each time demotion criteria is met.

In a more particular embodiment of such a slot game apparatus, the processor is configured to cause the display to present a different visual appearance for each stage of the at least one evolution-capable symbol.

In one embodiment, the predetermined number of winning outcomes is a single winning outcome, where in another embodiment the predetermined number of winning outcomes is greater than one.

In another embodiment of such a slot game apparatus, the processor is configured to decrease the evolution-capable symbol to the lower stage and utilize the respectively lower payout level when the demotion criteria involves the evolution-capable symbols failing to be involved in the predetermined number of winning outcomes. In another embodiment with different demotion criteria, the processor is configured to decrease the evolution-capable symbol to the lower stage and utilize the respectively lower payout level when the demotion criteria involves the evolution-capable symbol existing at a current stage for a predetermined number of the slot games. In still another embodiment involving different demotion criteria, the processor is configured to decrease the evolution-capable symbol to the lower stage and utilize the respectively lower payout level when the demotion criteria comprises passage of a time.

In yet another embodiment with different demotion criteria, the processor is configured to decrease the evolution-capable symbol to the lower stage and utilize the respectively lower payout level when the demotion criteria relates to a number of winning outcomes within a predetermined number of the slot games. In a more particular embodiment, the predetermined number of the slot games differs for each of the stages of the at least one evolution-capable symbol.

Another embodiment of such a slot game apparatus further includes a table of different payout levels for each of the stages of the evolution-capable symbol(s).

In still another embodiment of such a slot game apparatus, the processor is configured to provide multiple symbols as evolution-capable symbols, each having N stages ranging from a lowest stage to a highest stage.

This summary serves as an abbreviated, selective introduction of a representative subset of various concepts and embodiments that are further described or taught to those skilled in the art in the Specification herein. This summary is not intended to refer to all embodiments, scopes, or breadths of claims otherwise supported by the Specification, nor to identify essential features of the claimed subject matter, nor to limit the scope of the claimed subject matter.

### BRIEF DESCRIPTION OF THE DRAWINGS

FIG. 1 is a diagram of a representative gaming machine capable of facilitating player use and interaction with games and features in accordance with the invention and representative embodiments described herein.

FIG. 2 is a block diagram illustrating a representative computing arrangement capable of implementing games and features in accordance with the invention and representative embodiments described herein.

FIG. 3 depicts a representative manner in which one or more symbols are configured as multi-level symbols, each of which may evolve from one level to another level of the base symbol.

FIG. 4 depicts a representative paytable that accounts for different levels and intra-symbol payouts of one or more evolution-capable symbols.

FIG. 5 depicts a representative example of a slot game implementing evolution-capable, multi-level symbols implementing principles disclosed herein.

FIG. 6 is a flow diagram illustrating a representative slot game that incorporates symbol evolution principles described herein

FIGS. 7A, 7B and 7C depict some representative examples of the multi-level evolution of representative symbols.

FIGS. 8A and 8B depict an example of a poker game implementing the symbol evolution feature described herein.

FIGS. 9A and 9B are block diagrams of representative alternative slot game apparatuses having software-programmed or otherwise designed/configured hardware for conditionally enhancing gaming payouts in accordance with the disclosure.

### DETAILED DESCRIPTION

In the following description of various exemplary embodiments, reference is made to the accompanying drawings which form a part hereof, and in which is shown by way of illustration representative embodiments in which the features described herein may be practiced. It is to be understood that other embodiments may be utilized, as structural and operational changes may be made without departing from the scope of the disclosure.

In the description that follows, the terms “reels,” “cards,” “decks,” and similar mechanically descriptive language may be used to describe various apparatus presentation features, as well as various actions occurring to those objects (e.g., “spin,” “draw,” “hold,” “bet”). Although the present disclosure may be applicable to manual, mechanical, and/or computerized embodiments, as well as any combination therebetween, the use of mechanically descriptive terms is not meant to be only applicable to mechanical embodiments. Those skilled in the art will understand that, for purposes of providing gaming experiences to players, mechanical elements such as cards, reels, and the like may be simulated on a display in order to provide a familiar and satisfying experience that emulates the behavior of mechanical objects, as well as emulating actions that occur in the non-computerized games (e.g., spinning, holding, drawing, betting). Further, the computerized version may provide the look of mechanical equivalents but may be generally randomized in a different way. Thus, the terms “cards,” “decks,” “reels,” “hands,” etc., are intended to describe both physical objects and emulation or simulations of those objects and their behaviors using electronic apparatuses.

In various embodiments, the gaming displays are described in conjunction with the use of data in the form of “symbols.” In the context of this disclosure, a “symbol” may generally refer at least to a collection of one or more arbitrary indicia or signs that have some conventional or defined significance. In particular, the symbol may represent values that can at least be used to determine whether to award a payout. A symbol may include numbers, letters, shapes, pictures, textures, colors, sounds, etc., and any combination therebetween. A play state, such as a win, can be determined by comparing the symbol with one or more other symbols. Such comparisons can be performed, for example, via software by mapping numbers (or other data structures such as character strings) to the symbols and performing the comparisons on the numbers/data structures. Other conventions associated with known games (e.g., the numerical value/ordering of face cards and aces in card games) may also be programmatically analyzed to determine winning combinations.

Generally, systems, apparatuses and methods are described for enhancing player experiences by providing trigger-based evolution within a symbol, thereby enabling a symbol to be utilized at different levels which may correspond to different outcomes, probabilities, payouts, and/or other player benefits. The systems, apparatuses and methods described herein may be implemented as a single game, or part of a multi-part game. For example, the game features described herein may be implemented in primary gaming activities, bonus games, side bet games or other secondary games associated with a primary gaming activity. For example, the principles described herein may be used in an auxiliary feature, such as a bonus feature, such as a free games bonus feature or otherwise. In other embodiments, the principles described herein may be used in base/primary gaming activities, or other game play settings.

The game features may be implemented in stand-alone games, multi-player games, etc. Further, the disclosure may be applied to games of chance, and descriptions provided in the context of any representative game (e.g. slot game) is provided for purposes of facilitating an understanding of the features described herein. However, the principles described herein are equally applicable to any game of chance where an outcome(s) is determined for use in the player's gaming activity.

Embodiments of the present concept include providing gaming devices (also referred to as gaming apparatuses or gaming machines), gaming systems, and methods of operating these devices or systems to provide game play that involves evolving a symbol(s) from a one level of that symbol to another level of that symbol in response to determining that some criteria has been met, and to modify player benefits at least involving that symbol when at one level relative to that symbol at another level.

Numerous variations are possible in view of these and other embodiments of the inventive concept. Representative embodiments and variations are described herein, with some embodiments described with reference to the drawings. However, many other embodiments and variations exist that are covered by the principles and scope of this concept. For example, although some of the embodiments discussed below involve reel-based slot machine examples of this concept, other embodiments include application of these inventive techniques in other types of slot games, poker games, roulette, bingo, or other games of chance utilizing symbols that represent different levels, payout opportunities, etc. Some of these other types of embodiments will be discussed below as variations to the examples illustrated. However, many other types of games can implement similar techniques and fall within the scope of this disclosed concept.

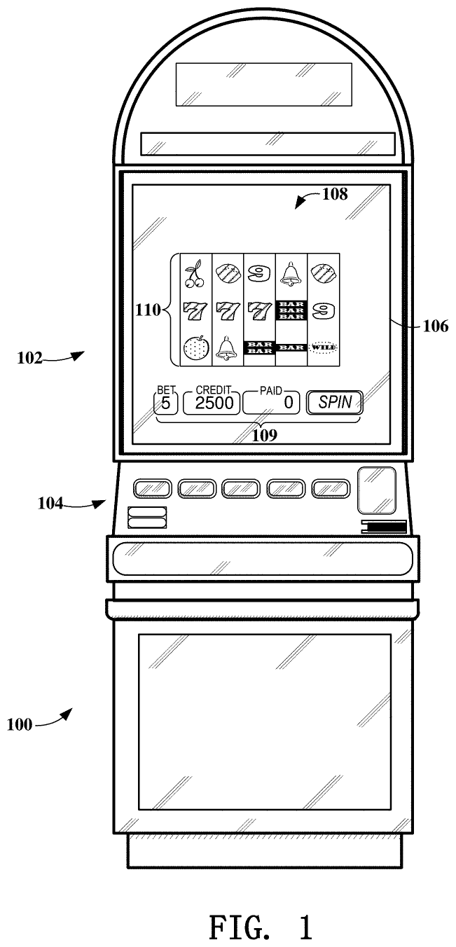

Referring to the example gaming apparatus 100 shown in FIG. 1, the representative gaming apparatus includes at least a display area(s) 102 (also referred to as a gaming display), and a player interface area(s) 104, although some or all of the interactive mechanisms included in the user interface area 104 may be provided via other or additional means, such as graphical icons used with a touch screen in the display area 102 in some embodiments. The display area 102 may include one or more game displays 106 (also referred to as “displays” or “gaming displays”) that may be included in physically separate displays or as portions of a common large display. Here, the representative game display 106 includes at least a primary game play portion 108 that displays game elements and symbols 110, and an operations portion 109 that can include meters, various game buttons and other input mechanisms, and/or other game information for a player of the gaming device 100.

The user interface 104 allows the user to control, engage in play of, and otherwise interact with the gaming machine 100. The particular user interface mechanisms included with user interface 104 may be dependent on the type of gaming device. For example, the user interface 104 may include one or more buttons, switches, joysticks, levers, pull-down handles, trackballs, voice-activated input, touchscreen input, tactile input, and/or any other user input system or mechanism that allows the user to play and interact with the particular gaming activity.

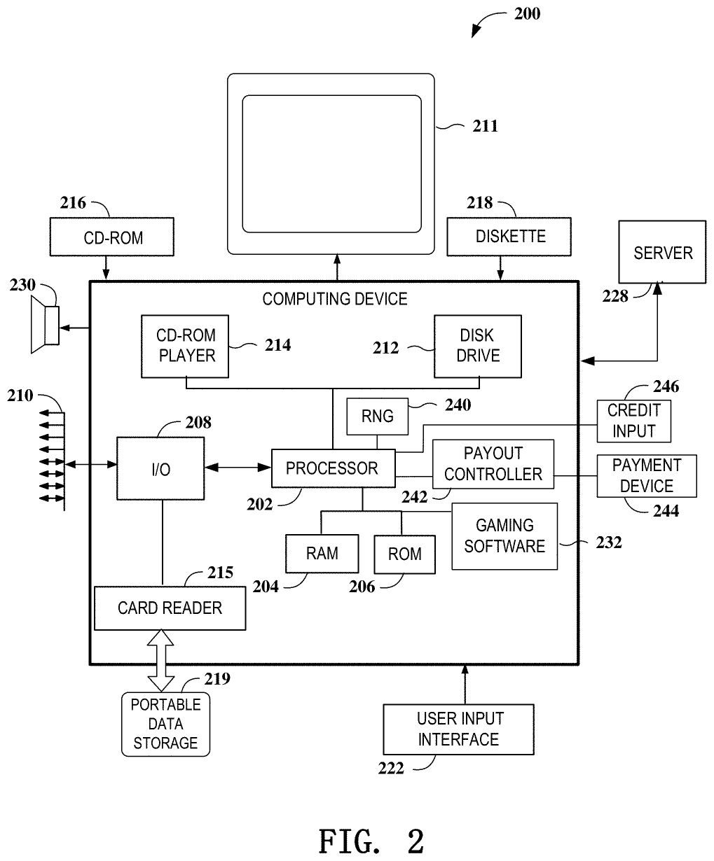

The user interface 104 may allow the user or player to enter coins, bills, or otherwise obtain credits through vouchers, tokens, credit cards, tickets, electronic money, etc. Various mechanisms for entering such vouchers, tokens, credit cards, coins, tickets, etc. are described below with reference to FIG. 2. For example, currency input mechanisms, card readers, credit card readers, smart card readers, punch card readers, radio frequency identifier (RFID) readers, and other mechanisms may be used to enter wagers. The user interface 104 may also include a mechanism to read and/or validate player information, such as player loyalty information to identify a user or player of the gaming device. This mechanism may be, for example, a card reader, biometric scanner, keypad, or other input device. It is through a user interface such as the user interface 104 that the player can initiate and engage in gaming activities. While the illustrated embodiment depicts various buttons for the user interface 104, it should be recognized that a wide variety of user interface options are available for use in connection with the present invention, including pressing buttons, touching a segment of a touch-screen, entering text, entering voice commands, or other known data entry methodology.

The game display 106 in the display area 102 may include one or more of an electronic display, a video display, a mechanical display, and fixed display information, such as pay table information associated with a glass/plastic panel(s) on the gaming machine 100 and/or graphical images. The symbols or other indicia associated with the play of the game may be presented on an electronic display device or on mechanical devices associated with a mechanical display. Generally, in some embodiments, the display 106 devotes the largest portion of viewable area to the primary gaming portion 108. The primary gaming portion 108 may provide visual feedback to the user for any selected game. The primary gaming portion 108 may render graphical objects such as cards, slot reels, dice, animated characters, and any other gaming visual known in the art. The primary gaming portion 108 may also inform players of the outcome of any particular event, including whether the event resulted in a win or loss.

In some example embodiments illustrated herein, the primary gaming portion 108 may display a grid (or equivalent arrangement) of game elements 110 or game element positions (also referred to herein as “reel stop positions”). As illustrated in the embodiment shown in FIG. 1, the grid includes three rows and five columns of game elements 110, which may form a game outcome(s) of a game play event from which prizes are determined. In some slot machine examples, each column may display a portion of a game reel. The game reels may include a combination of game symbols in a predefined order. In mechanical examples, the game reels may include physical reel strips where game symbols are shown in images fixed on the reel strips. Virtual reel strips may be mapped to these physical reel positions shown on the reel strips to expand the range or diversity of game outcomes. In video slot examples, reel strips may be encoded in a memory or database and virtual reels may be used for the game reels with images representing the data related to the reel strips. In other slot machine embodiments, each reel stop position on the grid may be associated with an independent reel strip. In yet other slot machine embodiments, reels and/or reel strips may not be used at all in determining the symbols shown in the game element positions of the grid. For example, a symbol may be randomly selected for each game element position, or the symbols may be determined in part by game events occurring during game play, such as displayed elements being replaced by new game elements or symbols. Numerous variations are possible for implementing slot-type game play.

The primary gaming portion 108 may include other features known in the art that facilitate gaming, such as status and control portion 109. As is generally known in the art, this portion 109 provides information about current bets, current wins, remaining credits, etc. associated with gaming activities of the grid of game elements 110. The control portion 109 may also provide touchscreen controls for facilitating game play. The grid of game elements 110 may also include touchscreen features, such as facilitating selection of individual symbols, or user controls over stopping or spinning reels. The game display 106 of the display area102 may include other features that are not shown, such as pay tables, navigation controls, etc.

Although FIG. 1 illustrates a particular implementation of some of the embodiments of this invention in a casino or electronic gaming machine (“EGM”), one or more devices may be programmed to play various embodiments of the invention. The concepts and embodiments described herein may be implemented, as shown in FIG. 1, as a casino gaming machine or other special purpose gaming kiosk as described herein, or may be implemented via computing systems operating under the direction of local gaming software, and/or remotely-provided software such as provided by an application service provider (ASP). Casino gaming machines may also utilize computing systems to control and manage the gaming activity, although these computing systems typically include specialized components and/or functionality to operate the particular elements of casino gaming machines. Additionally, computing systems operating over networks, such as the Internet, may also include specialized components and/or functionality to operate elements particular to these systems, such as random number generators. An example of a representative computing system capable of carrying out operations in accordance with the principles described herein is illustrated in FIG. 2.

Hardware, firmware, software or any combination thereof may be used to perform the various gaming functions, display presentations and operations described herein. The functional modules used in connection with the disclosure may reside in a gaming machine as described, or may alternatively reside on a stand-alone or networked computer. The representative computing structure 200 of FIG. 2 is an example of a computing structure that can be used in connection with such electronic gaming machines, computers, or other computer-implemented devices to carry out operations of the present invention. Although numerous components or elements are shown as part of this computing structure 200 in FIG. 2, additional or fewer components may be utilized in particular implementations of embodiments of the invention.

The example computing arrangement 200 suitable for performing the gaming functions described herein includes a processor, such as depicted by the representative central processing unit (CPU) 202, coupled to memory, such as random access memory (RAM) 204, and some variation of read-only memory (ROM) 206 or other persistent storage. The ROM 206 may also represent other types of storage media to store programs, such as programmable ROM (PROM), erasable PROM (EPROM or any technology capable of storing data). The processor 202 may communicate with other internal and external components through input/output (I/O) circuitry 208 and bussing 210, to communicate control signals, communication signals, and the like.

The computing arrangement 200 may also include one or more data storage devices, including hard and floppy disk drives 212, CD-ROM drives 214, card reader 215, and other hardware capable of reading and/or storing information such as DVD, etc. In one embodiment, software for carrying out the operations in accordance with the present invention may be stored and distributed on a CD-ROM 216, diskette 218, access card 219, or other form of computer readable media capable of portably storing information. These storage media may be inserted into, and read by, devices such as the CD-ROM drive 214, the disk drive 212, card reader 215, etc. The software may also be transmitted to the computing arrangement 200 via data signals, such as being downloaded electronically via a network, such as local area network (casino, property, or bank network) or a wide area network (e.g., the Internet). Further, as previously described, the software for carrying out the functions associated with the present invention may alternatively be stored in internal memory/storage of the computing device 200, such as in the ROM 206.

The computing arrangement 200 is coupled to one or more displays 211, which represent a manner in which the gaming activities may be presented. The display 211 represents the “presentation” of the game information in accordance with the disclosure, and may be a mechanical display showing physical spinning reels, a video display, such as liquid crystal displays, plasma displays, cathode ray tubes (CRT), digital light processing (DLP) displays, liquid crystal on silicon (LCOS) displays, etc., or any type of known display or presentation screen.

Where the computing device 200 represents a stand-alone or networked computer, the display 211 may represent a standard computer terminal or display capable of displaying multiple windows, frames, etc. Where the computing device 200 represents a mobile electronic device, the display 211 may represent the video display of the mobile electronic device. Where the computing device 200 is embedded within an electronic gaming machine, the display 211 corresponds to the display screen of the gaming machine/kiosk.

A user input interface 222 such as a mouse, keyboard/keypad, microphone, touch pad, trackball, joystick, touch screen, voice-recognition system, card reader, biometric scanner, RFID detector, etc. may be provided. The user input interface 222 may be used to input commands in the computing arrangement 200, such as placing wagers or initiating gaming events on the computing arrangement 200, inputting currency or other payment information to establish a credit amount or wager amount, inputting data to identify a player for a player loyalty system, etc. The display 211 may also act as a user input device, e.g., where the display 211 is a touchscreen device. In embodiments, where the computing device 200 is implemented in a personal computer, tablet, smart phone, or other consumer electronic device, the user interface and display may be the available input/output mechanisms related to those devices.

Chance-based gaming systems such as slot machines, in which the present invention is applicable, are governed by random numbers and processors, as facilitated by a random number generator (RNG) or other random generator. The fixed and dynamic symbols generated as part of a gaming activity may be produced using one or more RNGs. RNGs may be implemented using hardware, software operable in connection with the processor 202, or some combination of hardware and software. The principles described herein are operable using any known RNG, and may be integrally programmed as part of the processor 202 operation, or alternatively may be a separate RNG controller 240 that may be associated with the computing arrangement 200 or otherwise accessible such as via a network. The RNGs are often protected by one or more security measures to prevent tampering, such as by using secured circuitry, locks on the physical game cabinet, and/or remote circuitry that transmits data to the gaming device.

The computing arrangement 200 may be connected to other computing devices or gaming machines, such as via a network. The computing arrangement 200 may be connected to a network server(s) 228 in an intranet or local network configuration. The computer may further be part of a larger network configuration as in a global area network (GAN) such as the Internet. In such a case, the computer may have access to one or more web servers via the Internet. In other arrangements, the computing arrangement 200 may be configured as an Internet server and software for carrying out the operations in accordance with the present invention may interact with the player via one or more networks. The computing arrangement 200 may also be operable over a social network or other network environment that may or may not regulate the wagering and/or gaming activity associated with gaming events played on the computing arrangement.

Other components directed to gaming machine implementations include manners of gaming participant payment, and gaming machine payout. For example, a gaming machine including the computing arrangement 200 may also include a payout controller 242 to receive a signal from the processor 202 or other processor(s) indicating a payout is to made to a player and controlling a payout device 244 to facilitate payment of the payout to the player. In some embodiments, the payout controller 242 may independently determine the amount of payout to be provided to the participant or player. In other embodiments, the payout controller 242 may be integrally implemented with the processor 202. The payout controller 242 may be a hopper controller, a print driver, credit-transmitting device, bill-dispensing controller, accounting software, or other controller device configured to verify and/or facilitate payment to a player.

A payout or payment device 244 may also be provided in gaming machine embodiments, where the payment device 244 serves as the mechanism providing the payout to the player or participant. In some embodiments, the payment device 244 may be a hopper, where the hopper serves as the mechanism holding the coins/tokens of the machine, and/or distributing the coins/tokens to the player in response to a signal from the payout controller 242. In other embodiments, the payout device 244 may be a printer mechanism structured to print credit-based tickets that may be redeemed by the player for cash, credit, or other casino value-based currency or asset. In yet other embodiments, the payout device 244 may send a signal via the network server 228 or other device to electronically provide a credit amount to an account associated with the player, such as a credit card account or player loyalty account. The computing arrangement 200 may also include accounting data stored in one of the memory devices 204, 206. This accounting data may be transmitted to a casino accounting network or other network to manage accounting statistics for the computing arrangement or to provide verification data for the currency or currency-based tickets distributed by the payout device, such as providing the data associated with the bar codes printed on the currency-based tickets so they are identifiable as valid tickets for a particular amount when the player redeems them or inserts them in another gaming device.

The wager input module or device 246 represents any mechanism for accepting coins, tokens, coupons, bills, electronic fund transfer (EFT), tickets, credit cards, smart cards, membership/loyalty cards, or any other player assets, for which a participant inputs a wager amount. The wager input device 246 may include magnetic strip readers, bar code scanners, light sensors, or other detection devices to identify and validate physical currency, currency-based tickets, cards with magnetized-strips, or other medium inputted into the wager input device. When a particular medium is received in the wager input device 246, a signal may be generated to establish or increase an available credit amount or balance stored in the internal memory/storage of the computing device 200, such as in the RAM 204. Thereafter, specific wagers placed on games may reduce the available credit amount, while awards won may increase the available credit amount. It will be appreciated that the primary gaming software 232 may be able to control payouts via the payment device 244 and payout controller 242 for independently determined payout events.

Among other functions, the computing arrangement 200 provides an interactive experience to players via an input interface 222 and output devices, such as the display 211, speaker 230, etc. These experiences are generally controlled by gaming software 232 that controls a primary gaming activity of the computing arrangement 200. The gaming software 232 may be temporarily loaded into RAM 204, and may be stored locally using any combination of ROM 206, drives 212, media player 214, or other computer-readable storage media known in the art. The primary gaming software 232 may also be accessed remotely, such as via the server 228 or the Internet.

The primary gaming software 232 in the computing arrangement 200 may be an application software module. According to embodiments of the present invention, this software 232 provides a slot game or similar game of chance as described herein. For example, the software 232 may present, by way of the display 211, representations of symbols to map or otherwise display as part of a slot based game having reels. However, in other embodiments, the principles of this concept may be applied to poker games or other types of games of chance. One or more aligned positions of these game elements may be evaluated to determine awards based on a pay table. The software 232 may include instructions to provide other functionality as known in the art or as described and shown herein.

The systems, apparatuses and methods operable via these and analogous computing and gaming devices can support gaming features as described herein. In one embodiment, a slot game device is provided that includes a display presenting a plurality of symbol locations forming an array, a user interface, a wager input device structured to identify and validate player assets and to permit the player to play the slot game event when the player assets are provided, and a processor. The processor may be configured to evolve a symbol from one level of that symbol to another level of that symbol in response to determining that some criteria has been met, and to modify player benefits at least involving that symbol when at one level relative to that symbol at another level. Such principles are equally applicable to other gaming activities, such as video poker, keno, bingo, etc.

Many embodiments may be described in terms of a slot game, where symbols are matched on paylines to determine payout awards. However, the principles described herein are equally applicable to other games of chance, as described herein and as will be readily apparent to those skilled in the art from the teachings herein. In slot game embodiments, a subset of symbols (or all symbols in other embodiments) may be configured to evolve over time, and/or over certain game progressions (e.g., when winning, or alternatively when losing, etc.), and/or in connection with one or more game play occurrences (e.g., symbol combinations, occurrence of random/mystery events, etc.), and/or other defined parameters enabling such symbols to evolve over time. In one embodiment, such symbol evolution results in discrete stages or levels of a multi-level symbol as the symbol evolves, wherein some embodiments provide different rules and/or benefits for some or all of the different levels of such multi-level symbols. In other embodiments the levels may not precisely overlap into “discreet” levels, but rather some combination or migration of the rules/benefits may occur as the multi-level symbol evolves from level to level.

In some embodiments, at a multi-level symbol's current level, the rules, payouts, winning opportunities, and/or other game play parameters may differ from one, more, or all of the game play parameters for that multi-level symbol when at a different level. In some embodiments, these multi-level symbols may become of greater potential value to the player as it pertains to entertainment, wagering returns, wagering opportunities, and/or other aspects associated with playing the symbol-based gaming activity. For example, a subset of available symbols in a slot game may be designated as multi-level symbols that evolve into symbols of higher level (e.g., more beneficial to the player) in response to player actions and/or player results, such as winning a certain number of times in a row, winning a certain number of times in a period of time or over a number of “reel spins,” or the like.

As a representative example, certain “high-pay” symbols (e.g., those providing opportunities for the highest payouts) may be the symbols configured as multi-level symbols capable of evolving in response to a defined triggering event(s). Such multi-level symbols may begin at the lowest level, while in other embodiments one or more multi-level symbols may begin at a level that is not the lowest level, which could be provided in connection with other game play actions (e.g., a certain win, a certain symbol being randomly presented, etc.). In one embodiment, obtaining a certain number of wins with each level of the multi-level symbol would cause that multi-level symbol to “evolve” to a next higher level of the multi-level symbol. In one embodiment, such increase to a higher level of the multi-level symbol may occur for a certain amount of reel spins or other gaming events in a slot game, thereby potentially granting higher payouts due to the multi-level symbol being at a higher level that provides higher payouts than the same multi-level symbol would when at a lower level state. In one embodiment, if the player earns enough by way of payouts with that multi-level symbol at its current level, and/or earns enough consecutive wins or wins within some number of reel spins (or other criteria), and does so before an allotted number of gaming events (e.g., reel spins) has expired, the multi-level symbol will again evolve to a next higher level and potentially grant even higher payouts.

At the maximum level, the player may be eligible to win some maximum award, or other defined high-level award. For example, at a maximum level of an evolved multi-level symbol, the player may be eligible to win progressive jackpots, a full screen/window of the multi-level symbol, bonus events, free games, and/or any other prize(s) desired for the particular game.

In one embodiment, when a multi-level symbol evolves (e.g., changes from one level to another level), its appearance also changes to reveal its current state. For example, if a particular “major” symbol, Ml, was a blue dinosaur egg at Level 1, it may change appearance to be depicted as a baby dinosaur when evolved to Level 2. If reaching Level 3, such multi-level symbol may be depicted as a fully-grown dinosaur. Additional levels may be provided. In one embodiment, the symbol evolution principles described herein may apply to any symbol configured to have at least two levels or stages. A visual transformation may, or may not, be used to depict the evolution between symbol levels. In one embodiment, a visual representation, such as a video clip and/or series of images, may be presented somewhere in the game play area to depict the evolution of the multi-level symbol from one level to another level (whether increasing or decreasing levels), such as during a slot game reel spin that triggered the symbol evolution (e.g., on the reel or display segment that is being changed, anywhere on the game play area, on a separate display, etc.). In some embodiments, the modified symbol may be presented to reveal its new payout state, and/or may reference a payout table that includes (or modifies to) the newly-acquired level of the multi-level symbol, and/or may indicate its new value or worth in other manners.

Thus, in various embodiments, as a multi-level symbol evolves, the multi-level symbol may change in various ways, such as appearance, wagering opportunity, return on investment, etc., and continue to evolve “upwards” in this fashion as long as some criteria is met, and to return to a lower level (e.g., one level at a time, all the way to the first level, etc.) when the criteria is not met.

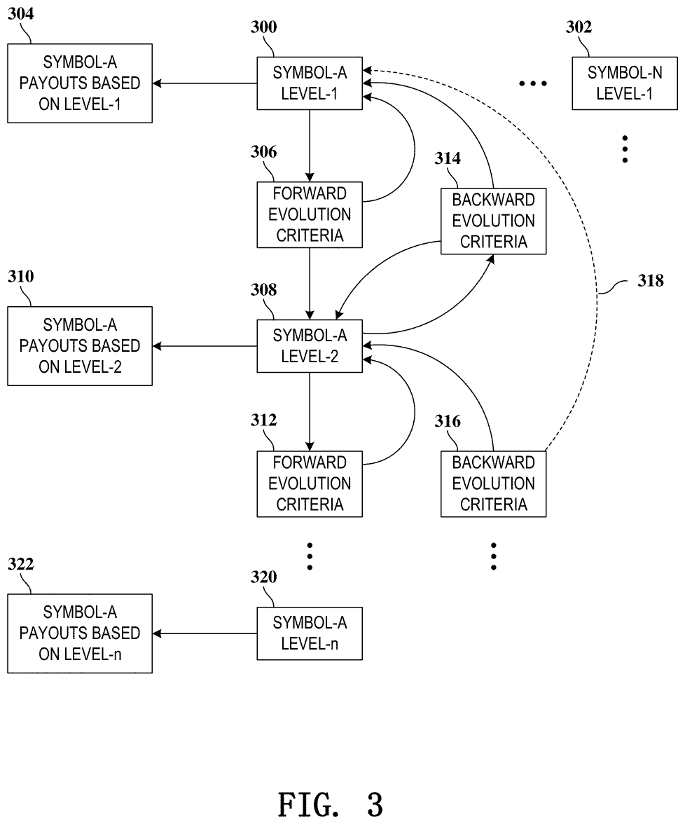

FIG. 3 is described in the context of such a slot game embodiment. This embodiment depicts a representative manner in which one or more symbols are configured as multi-level symbols, each of which may evolve from one level to another level of the base symbol. In this example, at least one multi-level symbol, i.e. Symbol-A, is configured to potentially evolve or transform between a plurality of intra-symbol levels. As previously noted, as few as one symbol, and as many as all symbols, may be configured as multi-level symbols in accordance with the present disclosure.

A Symbol-A, Level-1 300 is depicted, as are an indeterminate number of other multi-level symbols through Symbol-N, Level-1 302. Thus, one or more other multi-level symbols, depicted through Symbol-N, may instead or additionally be configured as multi-level symbols. In this example, Symbol-A, Level-1 300 represents the lowest level (e.g., Level-1) of the multi-level hierarchy for Symbol-A, where Level-2 is the next highest level, and so forth. The example of FIG. 3 depicts a representative progression of one of such multi-level symbols, namely Symbol-A, although other multi-level symbols (e.g., one or more symbols through some indeterminate Symbol-N) may exhibit the same or similar properties pertaining to the symbol evolution described herein.

In the example of FIG. 3, Symbol-A, Level-1 300 may represent a first phase or level of an evolution-capable, multi-level symbol. For example, Symbol-A, Level-1 300 may visually represent an early state of a person, object, or other item or concept that has perceivable stages associated therewith, whether naturally associated therewith or otherwise defined as such. As a more particular example, Symbol-A, Level-1 300 could represent a seed, or more particularly an acorn, where evolved subsequent stages might include a sprout, sapling, mature oak tree, etc. While the multi-level symbol is at Symbol-A, Level-1 300, payouts involving the multi-level Symbol-A may be based on a Level-1 payout scheme or paytable, such as identified at block 304. For example, if Symbol-A, Level-1 300 is an acorn symbol, the payout for obtaining three consecutive acorn symbols may be (for example) twenty credits. As described further below in this representative example, some embodiments enable higher payouts and/or higher paytables (or analogous payout/award methodology) for such multi-level symbols when they have evolved to respectively higher levels, such as a multi-level symbol that has evolved from an acorn to a sapling now providing a payout of fifty credits for obtaining three consecutive evolved sapling symbols.

Criteria may be predefined, or in other embodiments established in an ad hoc manner during game play, to identify if, when, and/or how a multi-level symbol may evolve to a next level (whether immediately succeeding, skipping ahead by more than one level, etc.). In the representative embodiment of FIG. 3, the forward evolution criteria 306 represents criteria against which game play activity (which may or may not involve Symbol-A) will be compared. Representative examples of such criteria may include, for example, a consecutive number of wins, a consecutive number of wins involving the particular Symbol-A, a number of wins in a particular time period or within a number of reel spins or other slot game events, a number of wins involving the particular Symbol-A in a particular time period or within a number of reel spins or other slot game events, a payout threshold (whether a high threshold, low threshold, etc.) based on time of play or number of reel spins, a payout threshold (whether a high threshold, low threshold, etc.) involving the particular Symbol-A based on time of play or number of reel spins, a particular symbol(s) or other event randomly occurring in connection with participation in the gaming activity, and/or the like. The representative forward evolution criteria described herein merely sets forth examples of criteria that could be used to facilitate an understanding of how such criteria may be employed in connection with the principles described herein, and is not an exhaustive list.

When such forward evolution criteria 306 is met, the Symbol-A evolves to the next level, identified as Symbol-A, Level 2 308 in this example (although the forward evolution could move farther upward than the immediately succeeding level in some embodiments). For example, assume the forward evolution criteria 306 included obtaining three wins in five reel spins when the symbol is currently at Symbol-A, Level-1 300, and such criteria was met, the symbol would evolve from Symbol-A, Level-1 300 to Symbol-A, Level-2 308. At this level, one embodiment involves enhancing the payouts and/or paytables involving at least the Symbol-A, such as depicted by block 310 where payouts are now based on Level-2 of Symbol-A. Other manifestations of the symbol evolution may also be implemented, such as visually or otherwise perceptibly changing the symbol state from one level to another level.

Play may continue with Symbol-A, Level-2 308, operating with payouts based on Level-2 310, until further forward evolution criteria 312 is met to enable progression to a still further level. In one embodiment, play may continue indefinitely until, for example, a player cashes out at the higher symbol evolution level. In other embodiments, play may continue at a particular level (e.g., Symbol-A, Level-2 308) until evolving upwards based on forward evolution criteria 312, or until backward evolution criteria 314 is met whereby Symbol-A no longer qualifies to remain at the current level (Symbol-A, Level-2 308) and is demoted at least one level, such as back to Symbol-A, Level-1 300 in the illustrated example. In some embodiments, meeting backward evolution criteria (e.g., backward evolution criteria 316) may cause the symbol to transform back multiple levels, including an embodiment where the symbol is transformed back to the base level symbol-A, Level-1 300, as depicted by dashed line 318.

Backward evolution criteria may be set as desired, such as a fixed or random number of reel spins, a fixed or random time, failing to win a particular threshold of payout amounts in a time or number of reel spins, winning over a threshold of payout amounts in a time or number of reel spins, a random event occurring, etc. The representative backward evolution criteria described herein merely sets forth examples of criteria that could be used to facilitate an understanding of how such criteria may be employed in connection with the principles described herein, and is not an exhaustive list.

Forward evolution may occur as long as available levels for a particular symbol exist, such as depicted by the indeterminate symbol level Symbol-A, Level-n 320, which would involve a corresponding payout based on Level-n as depicted by block 322. While some embodiments involve at least some differences in paytables and/or other payout values (e.g., increasing payouts for a particular symbol as it evolves up the evolution chain), other embodiments may not provide differences at every level, or different levels may have different benefits for payouts involving that multi-level symbol (e.g., some levels providing higher payouts, some levels enabling fewer symbols of the combination to create a payout, increasing or otherwise adjusting the number of paylines available for symbol combinations involving that particular sub-symbol, etc.).

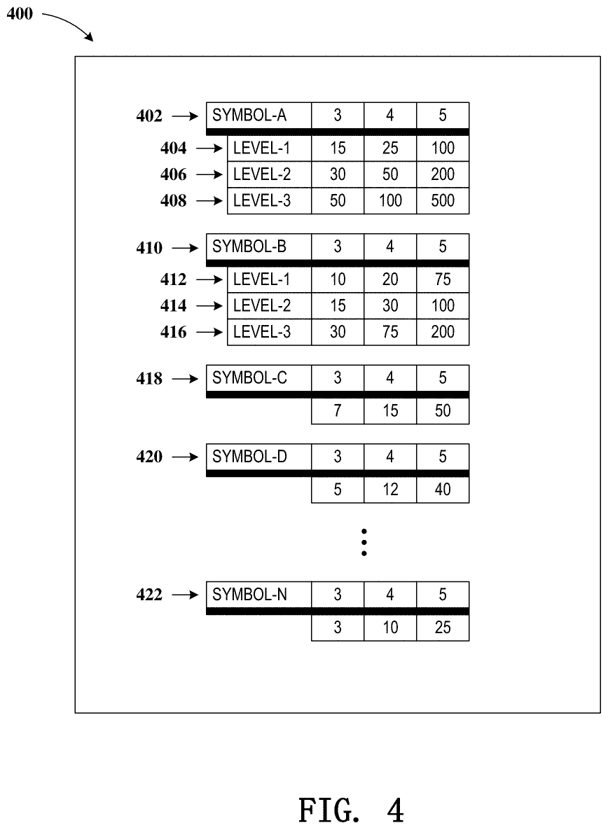

As noted in the example of FIG. 3, one embodiment involves modifying payouts associated with an evolution-capable symbol as it evolves from one level to the next. This modification of payouts may, for example, increase as the symbol evolves “upward” and decrease as the symbol evolves “downward.” In one embodiment, such payout modifications may be implemented by providing paytables that account for different levels of symbols capable of evolution. FIG. 4 depicts a representative paytable that accounts for different levels and intra-symbol payouts of one or more evolution-capable symbols.

A display 400 or other presentation area may be used to present the paytables or other information identifying gaming activity payouts. The example of FIG. 4 assumes payouts based on symbol combinations of a plurality of symbols, identified as Symbol-A 402, Symbol-B 410, Symbol-C 418, Symbol-D 420, through some indeterminate number of such symbols identified as Symbol-N 422. Other manners of obtaining payouts or returns on wagers may alternatively or additionally be implemented, but the example of FIG. 4 is provided for purposes of facilitating an understanding of a representative manner of distinguishing payouts for evolution-capable multi-level symbols described herein.

In this example, Symbol-A 402 and Symbol-B 410 represent multi-level symbols that can evolve from one level to another, while Symbol-C 418, Symbol-D 420 through Symbol-N 422 represent standard symbols not configured to exhibit such evolution-capable characteristics. For purposes of illustration, this example assumes payouts for symbol combinations of three, four, and five like symbols on a payline (or anywhere on the grid for a scatter pay, etc.). However, any symbol combination scheme (including a single symbol in some cases) or other defined rules may be used to identify payouts using symbols.

Multi-level Symbol-A 402 is configured as a three-level symbol, including Level-1 404, Level-2 406 and Level-3 408. When Symbol-A 402 is at its lowest level, i.e. Level-1 404, occurrence of a three-symbol combination will pay out 15 credits, occurrence of a four-symbol combination will pay out 25 credits, and occurrence of a five-symbol combination will pay out 100 credits. This will continue to be the pay scheme for Symbol-A 402 until something occurs to trigger the evolution of Symbol-A 402 from Level-1 404 to Level-2 406. It should be noted that in some embodiments, an evolution of greater than one level may occur, which may be based on rules, randomly, etc.

If and when the Symbol-A 402 evolves from Level-1 404 to Level-2 406 (e.g., in response to a win(s) with Symbol-A 402 when at Level-1 404), the Level-2 406 payouts are then used as long as rules (including a rule indicating random termination) allow it to remain there. In this example, when Symbol-A 402 is at Level-2 406, occurrence of a three-symbol combination will pay out 30 credits, occurrence of a four-symbol combination will pay out 50 credits, and occurrence of a five-symbol combination will pay out 200 credits. This will continue to be the pay scheme for Symbol-A 402 until something occurs to trigger the evolution of Symbol-A 402 from Level-2 406 to Level-3 408, or to trigger the evolution of Symbol-A 402 back to Level-1 404.

If and when the Symbol-A 402 evolves from Level-2 406 to Level-3 408 (e.g., in response to a win(s) with Symbol-A 402 when at Level-2 406), the Level-3 408 payouts are then used as long as rules allow it to remain there. In this example, when Symbol-A 402 is at Level-3 408, occurrence of a three-symbol combination will pay out 50 credits, occurrence of a four-symbol combination will pay out 100 credits, and occurrence of a five-symbol combination will pay out 500 credits. This will continue to be the pay scheme for Symbol-A 402 until something occurs to trigger the evolution of Symbol-A 402 back to a lower level, Level-2 406 or Level-1 404 (since Level-3 408 is the highest level in this particular example).

Thus, as can be seen, depending on the success of Symbol-A 402 meeting the criteria associated with evolving to a higher level, payouts may increase when the evolved symbol combinations occur relative to that same symbol when at a lower level.

Symbol-B 410 is also configured to be a multi-level symbol that can evolve from one level to another, which is a three-level symbol in this embodiment, including Level-1 412, Level-2 414 and Level-3 416. When Symbol-B 410 is at its lowest level, i.e. Level-1 412, occurrence of a three-symbol combination will pay out 10 credits, occurrence of a four-symbol combination will pay out 20 credits, and occurrence of a five-symbol combination will pay out 75 credits. This will continue to be the pay scheme for Symbol-B 410 until something occurs to trigger the evolution of Symbol-B 410 from Level-1 412 to Level-2 414.

If and when the Symbol-B 410 evolves from Level-1 412 to Level-2 414 (e.g., in response to a win(s) with Symbol-B 410 when at Level-1 412), the Level-2 414 payouts are then used as long as the rules allow it to remain there. In this example, when Symbol-B 410 is at Level-2 414, occurrence of a three-symbol combination will pay out 15 credits, occurrence of a four-symbol combination will pay out 30 credits, and occurrence of a five-symbol combination will pay out 100 credits. This will continue to be the pay scheme for Symbol-B 410 until something occurs to trigger the evolution of Symbol-B 410 from Level-2 414 to Level-3 416, or to trigger the evolution of Symbol-B 410 back to Level-1 412.

If and when the Symbol-B 410 evolves from Level-2 414 to Level-3 416 (e.g., in response to a win(s) with Symbol-B 410 when at Level-2 414), the Level-3 416 payouts are then used as long as rules allow it to remain there. In this example, when Symbol-B 410 is at Level-3 416, occurrence of a three-symbol combination will pay out 30 credits, occurrence of a four-symbol combination will pay out 75 credits, and occurrence of a five-symbol combination will pay out 200 credits. This will continue to be the pay scheme for Symbol-B 410 until something occurs to trigger the evolution of Symbol-B 410 back to a lower level, Level-2 414 or Level-1 412 (since Level-3 416 is the highest level in this particular example).

Thus, as can be seen, depending on the success of Symbol-B 410 meeting the criteria associated with evolving to a higher level, payouts may increase when the evolved symbol combinations occur relative to that same symbol when at a lower level. Symbol-C 418, Symbol-D 420, and any other symbols through Symbol-N 422 are each single-level symbols in the embodiment of FIG. 4. For example, occurrence of a four-symbol combination for Symbol-D 420 will pay out 12 credits, and so forth.

As indicated, player benefits for symbol evolution may vary depending on the desired characteristics of the game. Such benefits may include any one or more of increased payouts, free games, increased chances to obtain benefits such as free games or bonus events, easier winning criteria (e.g. fewer like symbols to reach winning payout, etc.), increased paylines or ways to identify winning results, enriched slot reels (e.g. add and/or remove symbols to increase the chances of obtaining winning results with one or more of the symbols), and the like. For example, in one embodiment, payouts and/or paytables are adjusted to provide higher potential returns to the player. Example 1 below depicts one representative example involving higher payouts:

### Higher Payouts

3 “S” symbols at Level-1 pays 100 credits
3 “S” symbols at Level-2 pays 150 credits
3 “S” symbols at Level-3 pays 250 credits

### Example 1

Example 2 below depicts another representative example, where at least additional “S” symbols are inserted onto the reels to increase the chances of payouts involving “S” symbols:

### Enriched Reels

50 “S” symbols inserted at Level-1
100 “S” symbols inserted at Level-2
150 “S” symbols inserted at Level-3

### Example 2

In some embodiments, added symbols may be randomly added throughout the reel(s), where in other embodiments they may be added in small sets (e.g. multiple groups of four adjacent “S” symbols), where still in other embodiments the additional symbols may be added in one large group (e.g. one group of fifty adjacent “S” symbols), or the like.

Example 3 below depicts yet another representative example, where progressive jackpots may be activated depending on the level of one or more particular symbols:

### Jackpot Activation

Jackpot-1 activated at Level-1
Jackpot-2 activated at Level-2
Jackpot-3 activated at Level-3

### Example 3

In another embodiment, jackpots or other awards may be awarded when other criteria is met, such as a full screen (or some determined number) of a particular evolution-capable symbol(s) occurs. Such an embodiment may work well in conjunction with embodiments involving the inclusion of symbol stacks onto slot reels, such as was described in connection with Example 2. Example 4 below provides one such representative example:

### Progressive Awards

Full-screen of “S” symbols at Level-1 grants Progressive Jackpot-1
Full-screen of “S” symbols at Level-2 grants Progressive Jackpot-2
Full-screen of “S” symbols at Level-3 grants Progressive Jackpot-3

### Example 4

These represent examples of the types of advantages that may be provided to a player as a symbol evolves. Multiple different evolution-capable symbols may also be used, to further increase potential player benefits.

It should also be recognized that the payouts may instead include, or also include, awards or features other than “credits.” Therefore, where “credits” is used in connection with the example of FIG. 4 and elsewhere herein, the principles described herein are equally applicable to other awards, such as, for example, cash or other direct assets, multipliers or other payout modifiers, casino perks, free spins/plays, bonus events, and/or the like.

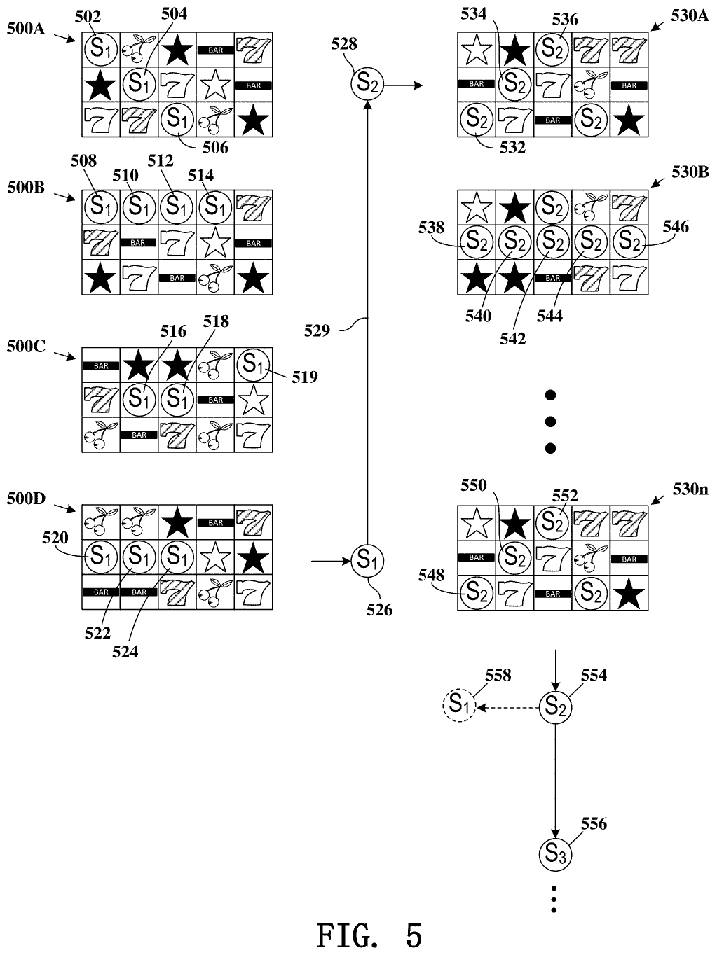

FIG. 5 depicts a representative example of a slot game implementing evolution-capable, multi-level symbols implementing principles disclosed herein. This example assumes at least three levels for a symbol “S,” where a first/lowest level is designated as S₁, a second level is designated S₂, a third level is designated S₃, and so forth. This example also assumes that three, four, or five like symbols occurring adjacently along a payline provide a payout, with amounts depending on the particular symbol involved, the number of like symbols appearing adjacently along the payline, etc. The principles described herein apply equally to other payout schemes, whether symbols along paylines, dynamically-generated paylines based on adjacency of symbols occurring, scatter pays, etc. Therefore, the description of FIG. 5 is for purposes of illustration and not of limitation, as those skilled in the art will readily understand the ability to implement such principles in different wagering environments from the teachings herein.

For purposes of this example, a first consecutive series of slot game events (e.g. slot game spins) is depicted via slot game result 500A, slot game result 500B, slot game result 500C, and slot game result 500D. In this example, a criterium for a symbol “S” to evolve from a current level to a next level is to obtain three wins in X slot game events (e.g. spins), such as three wins with the “S” symbol in any five spin span. This is only an example of such a criterium, as other criteria may be employed, such as X wins with the S symbol regardless of the number of attempts (e.g. as soon as three wins with the “S” symbol occur, even if it takes ten, twenty, or more slot game events), one or more wins with the “S” symbol where there are a minimum number of such “S” symbols involved with the payout (e.g. evolve upwards after a five-symbol win with the “S” symbol), and/or any other defined criteria. Thus, while the example of FIG. 5 assumes an upwards evolution criteria of three wins in any five spin range involving the “S” symbol, this is a representative criterium for purposes of example only.

As seen in the slot game result 500A, three “S” symbols at its first level (Level-1) have occurred, depicted as S₁ 502, S₁ 504, and S₁ 506, which are assumed to have occurred on a payline where three adjacent like symbols on a payline result in a win and concomitant payout. Therefore, one win has occurred that involves the “S” symbol at its current level, Level-1. If two more winning events occur involving the “S” symbol in the next four slot game events, the “S” symbol will evolve to the next level, Level-2.

Slot game result 500B shows the “S” symbol again occurring in a sufficient number of adjacent locations along a payline that results in another wining payout, namely S₁ 508, S₁ 510, S₁ 512 and S₁ 514 occurring on a top-row horizontal payline. Thus, at this point, two wins have occurred that involve the “S” symbol at its current Level-1, and if one more winning event occurs involving the “S” symbol in the next three slot game events, the “S” symbol will evolve to the next level, Level-2.

Slot game result 500C shows the “S” symbol again occurring on the grid, including S₁ 516, S₁ 518, and S₁ 519. These three occurrences of the Level-1 “S” symbol did not, however, occur in a sufficient number of adjacent grid locations to result in a winning result, and therefore does not count towards the threshold (in this example) of three wins involving the “S” symbol in a range of five reel spin events. Consequently, at this point, the status remains the same as after the slot game result 500B, where two wins have occurred that involve the “S” symbol at its current Level-1, but now requires (in this example) one more winning event involving the “S” symbol in the next two slot game events to evolve the “S” symbol to the next level.

Slot game result 500D shows the “S” symbol again occurring in a sufficient number of adjacent locations along a payline that results in another wining payout, namely S₁ 520, S₁ 522, and S₁ 524 occurring on a middle-row horizontal payline. At this point, three wins have occurred that involve the “S” symbol at its current Level-1 within a range of five slot game events (i.e. four slot games events 500A, 500B, 500C, 500D in this example), and therefore the criterium has been met with respect to the “S” symbol to evolve the “S” symbol from its current level S₁ 526 to its next level S₁ 528 as depicted by the evolution line 529. The “S” symbol has now evolved to a level, temporarily in some embodiments, where payouts and/or other game-related characteristics (e.g. number of “S” symbols required to result in a win, allowing scatter pays rather than just payline pays, etc.) are, at least in some respect(s) in this embodiment, more favorable to the player than the prior level.

A first slot game result 530A depicts the newly-evolved S₂ symbol occurring in a sufficient number of adjacent locations along a payline that results in a wining payout, namely S₂ 532, S₂ 534, and S₂ 536 occurring on a diagonal payline. Therefore, one win has occurred that involves the “S” symbol at its current level, Level-2. Where the evolution to S₂ involves a higher paytable for wins involving the “S” symbol at Level-2 relative to Level-1, such payout will be heightened, thereby benefiting the player relative to the Level-1 state. If two more winning events occur involving the “S” symbol in the next four slot game events, the “S” symbol will evolve to the next level, Level-3. In one embodiment, if two more winning events do not occur involving the “S” symbol in the next four slot game events, the “S” symbol will return to a lower level (e.g. the immediately preceding level, a base/lowest level, etc.).

Slot game result 530B shows the “S” symbol again occurring in a sufficient number of adjacent locations along a payline that results in another wining payout, namely S₂ 538, S₂ 540, S₂ 542, S₂ 544, and S₂ 546 occurring on a middle-row horizontal payline. Again, in one embodiment, payouts may be enhanced at this Level-2 state of the “S” symbol relative to the Level-1 state. At this point, two wins have occurred that involve the “S” symbol at its current Level-2, and if one more winning event occurs involving the “S” symbol in the next three slot game events, the “S” symbol will evolve to the next level, Level-3.

A number of additional slot game events (e.g. reel spins) occur, and eventually another win occurs involving the “S” symbol as depicted at slot game result 530n. Specifically, S₂ 548, S₂ 550, and S₂ 552 occur along a diagonal payline in a sufficient number to result in a winning payout. If this winning result involving the “S” symbol occurred within the five-spin range (in this example), the S₂ 554 symbol will again evolve upwards, to an S₃ 556 level where new slot game events can be participated in using the S₃ 556 symbol. Alternatively, in one embodiment, if no winning result involving the “S” symbol occurred within the five-spin range (in this example), the S₂ 554 symbol will revert to a lower level, which is the S₁ 558 level in this example.

FIG. 5 depicts one representative example of the evolution of a symbol in connection with a slot game event. Another representative example assumes a player gets a winning result in a slot game with a symbol S when at a current level such as Level-1. The symbol S is, in this new example, now a candidate for evolution. In this example, the player is to get two more winning results with the “S” symbol (for a total of three required wins) for the symbol to evolve from Level-1 to Level-2, regardless of how many future reel spins it takes. Assume that the player obtains two more wins with the “S” symbol (for a total of three wins), thereby causing the “S” symbol to evolve into the Level-2 version, which in this example grants higher payouts for wins involving that “S” symbol. In this example, the evolved “S” symbol will last for some number of future reel spins, such as a predetermined number of spins, a randomly-determined number of spins, etc. In this example, it is assumed that the evolved “S” symbol will last for ten (10) more reel spins, and the player must obtain six (6) winning results involving the “S” symbol within those ten reel spins, the “S” symbol will be able to evolve from Level-2 to Level-3, which in this example is the maximum level. Assume the player successfully gets six wins involving the “S” symbol over the next ten reel spins, which causes the “S” symbol to evolve from Level-2 to Level-3, which grants even higher payouts for winning results involving the “S” symbol in this example. The “S” symbol will remain at Level-3 for ten more spins in this example, and after the tenth reel spin, the “S” symbol will return to its base Level-1, allowing the player to try again to “level up” their symbol for higher payouts.

It should be recognized that in other embodiments, paytables may increase, as a result of a symbol evolution, for those payouts involving the symbol “S,” or may instead or additionally increase for one or more other symbols, or all symbols, during the enhanced level period. Thus, while the example above involves increasing payouts for winning results involving the “S” symbol, other embodiments may involve increasing all payouts, or all payouts involving some subset of symbols, etc. Higher levels may also or instead provide other benefits, such as beneficially adjusting the number of symbols required to obtain a winning result, enabling scatter pays versus payline-dependent winning events, the inclusion of bonus events, the inclusion of free spin events, and/or the like.

Another representative example assumes a player get a winning result in a slot game with a symbol S when at a current level such as Level-1. The symbol S is, in this new example, now a candidate for evolution. In this example, the player must get two more winning results (for a total of three winning results) with the “S” symbol for the symbol to evolve from Level-1 to Level-2, regardless of how many future reel spins it takes. Assume that the player eventually obtains two more wins with the “S” symbol (for a total of three wins), thereby causing the “S” symbol to evolve into the Level-2 version, which in this example grants higher payouts for wins involving that “S” symbol. In this example, the evolved “S” symbol will last for some number of future reel spins, such as a predetermined number of spins, a randomly-determined number of spins, etc. In this example, it is assumed that the evolved “S” symbol will last for ten (10) more reel spins, and the player must obtain six (6) winning results involving the “S” symbol within those ten reel spins, the “S” symbol will be able to evolve from Level-2 to Level-3, which in this example is the maximum level. Assume the player fails to get six wins involving the “S” symbol over the next ten reel spins. This causes the “S” symbol to return to Level-1, allowing the player to try again to “level up” their symbol(s) for higher pays and/or other player benefits.

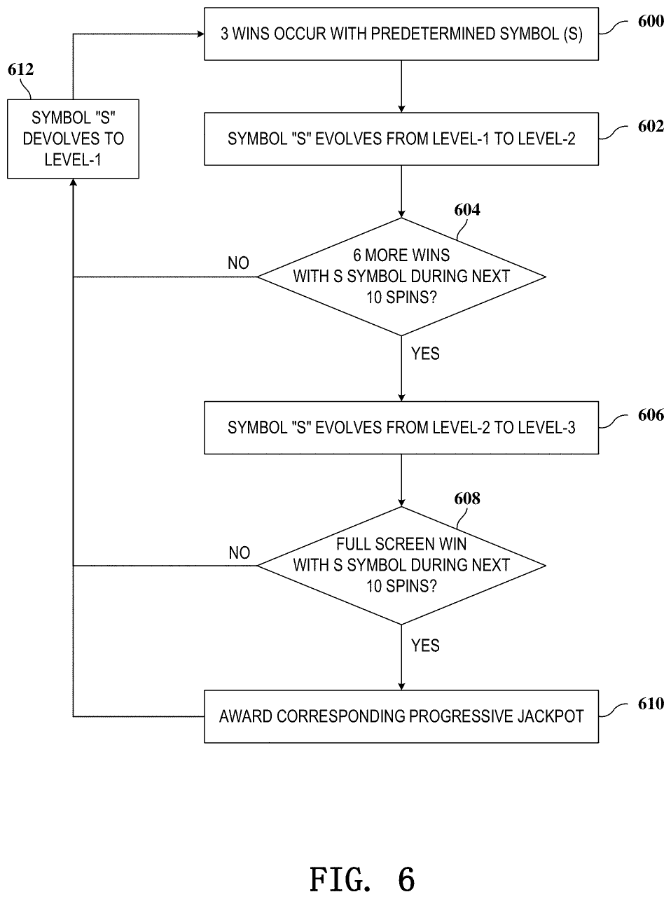

FIG. 6 is a flow diagram illustrating a representative slot game that incorporates symbol evolution principles described herein. The particular number of symbols, numbers of wins to change levels, particular player benefits, and/or other characteristics of FIG. 6 merely represent one embodiment, and variations as described herein may be employed to create similar operational methodologies that are structurally embodied to provide gaming devices and systems.

In the example of FIG. 6, it is assumed that three wins involving a particular symbol(s) (symbol “S” in this example) occur 600. As a result of gaming criteria associated with the game, the symbol S evolves 602 from its current Level-1 to the next Level-2. As determined at block 604, if six more wins do not occur with the S symbol during the next ten slot spin events, the symbol S devolves 612 from its current Level-2 to Level-1. On the other hand, if six more wins do occur with the S symbol during the next ten slot spin events, the symbol S evolves 606 from its current Level-2 to the next Level-3.

In the present example, different player benefits are granted in connection with different symbol evolution levels. In the illustrated example, no direct benefit (e.g. higher payouts, etc.) are provided by reaching Level-2, but rather it serves as a step towards Level-3, where a higher player benefit may be obtained. Particularly, in this example, when the symbol S is at Level-2, it is then determined 608 whether a full screen win with the symbol S (or alternatively some threshold number of S symbols that is less than a full screen) occurs during the next ten reel spin events. If not, the symbol S devolves from its current Level-3 back to Level-1 (although other embodiments would devolve only to Level-2, for example). If so, then a corresponding progressive jackpot is awarded 610, before the symbol S devolves back to Level-1 in this example.

FIG. 6 is a flow diagram representing a representative method in which a gaming device and/or gaming system can be operated according to representative embodiments. Although various processes are shown in a particular order in this and other flow diagrams herein, the order of these processes can be changed in other embodiments without deviating from the scope or spirit of this concept. Accordingly, the order of the processes shown is for illustrative purposes only and is not meant to be restrictive. Additional game processes may also be included between various processes even though they are not shown in these flow diagrams for purposes of clarity. Each of the processes may be performed by components in a single game device, such as by a game processor(s), or may be performed in part or whole by a remote server or processor(s) connected to the gaming device via a network. Each process may be encoded in instructions that are stored in one or more memories, a computer-readable medium(s), or another type of storage device(s). The exemplary methods depict representative embodiments of how game operations may be implemented. As discussed herein, many variations exist which may require additional, fewer, or different processes to complete.

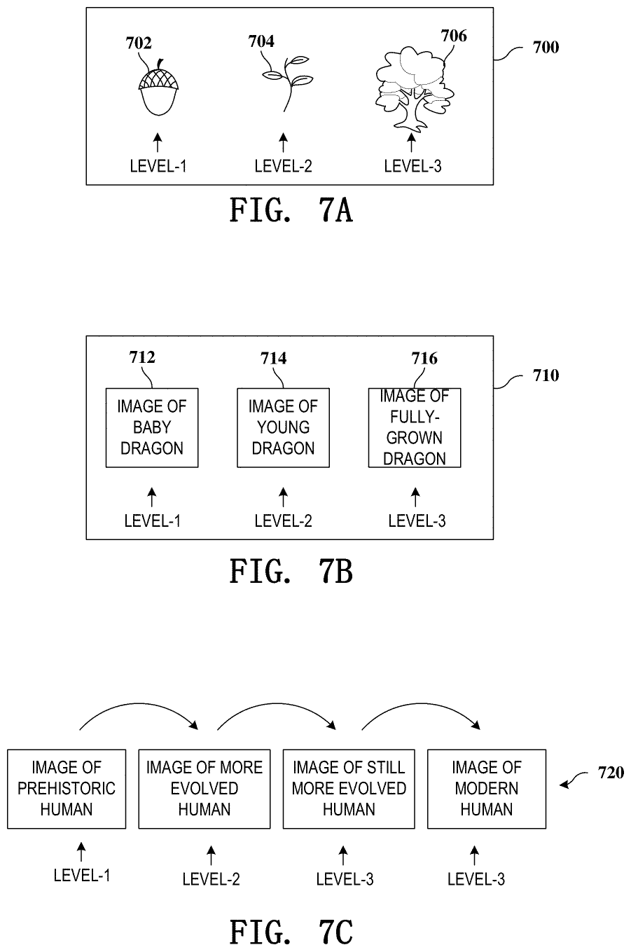

Any manner of establishing levels for evolution-capable symbols may be employed. In some embodiments, the multi-level symbol established to follow a familiar progression, while in other embodiments the progression may be random, or obscure, or contrived, etc. FIGS. 7A, 7B and 7C depict some representative examples of the multi-level evolution of representative symbols.

FIG. 7A depicts a multi-level symbol 700 based on a familiar progression of a known tree. The symbol 700 in this example involves three levels, including Level-1 as an acorn 702, Level-2 as a sapling 704, and Level-3 as an oak tree 706. Such levels may be visually and/or otherwise perceivably changed in such manners as the symbol 700 evolves between levels. FIG. 7B depicts a multi-level symbol 710, including Level-1 as a baby dragon 712, Level-2 as a young dragon 714, and Level-3 as a fully-grown dragon 716. In yet another example, symbol 720 includes various stages of human evolution, including Level-1, Level-2, Level-3, and Level-4 corresponding to stages of the symbol 720.

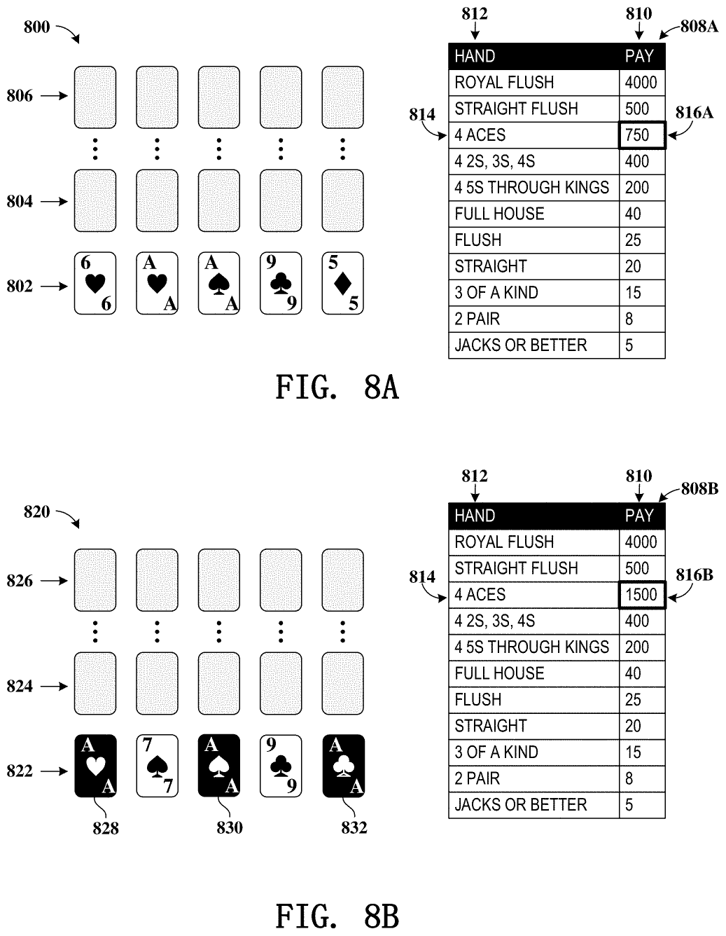

The principles described herein may be implemented in any games, such as games of chance involving wagering activities (whether real money or not), and more particularly to gaming activities such as slot games, poker games, keno games, bingo games, roulette games, and any other gaming activity utilizing a symbol or number where levels can be attributed thereto. FIGS. 8A and 8B depict one such example, in the context of a poker game, where multiple levels may be attributed to known poker symbols to provide the symbol evolution feature described herein.

The example involving FIGS. 8A and 8B is described in the context of a video/electronic poker game, although the principles are equally applicable in other embodiments such as in a physical poker context. The poker game may be played with a single hand, whether a stud poker game, draw poker game, etc. The embodiment of FIGS. 8A and 8B is described in the context of a multi-play poker game, where a plurality of hands are concurrently played. A multi-hand or multi-play context as used herein refers to a plurality of poker hands played concurrently, where cards held in at least one hand are replicated as held cards into one or more of the other concurrently-played hands. However, it should be noted that other multiple-hand embodiments may involve concurrently-played poker hands, without the replication of a first hand(s) held cards to serve as one or more other hand's held cards. In other words, other multiple-hand embodiments that are not “multi-play” as used herein may be used in connection with the teachings of the present disclosure, as the held cards would not have to be replicated.

FIG. 8A depicts a multi-play poker game 800 including a first hand 802, and one or more additional hands 804, 806. In this example, assume that at least an Ace is configured as an evolution-capable, multi-level symbol. FIG. 8A may represent Aces when at their lowest level, such as Level-1. A paytable 808A may identify payouts 810 for particular hands 812. For example, when Aces are at Level-1, the paytable 808A indicates that “4 Aces” 814 results in a pay 810 of 750 credits 816A.

A criterium, or criteria, may be implemented as part of the poker game 800 that causes the Ace symbol (and/or any other desired symbol(s)) to evolve from its current level to another level. For example, obtaining three-of-a-kind in Aces may trigger the evolution of the Aces in the deck(s) to a next level, such as Level-2, whereby payouts and/or other player benefits are heightened (in some embodiments). In the illustrated embodiment, when at Level-2, payouts involving “4 Aces” 814 are increased, as depicted at FIG. 8B.

More particularly, assume a newly dealt poker game 820 is presented when the Aces have evolved to Level-2. Poker game 820 includes a first hand 822, and one or more additional hands 824, 826. In one embodiment, the evolution of the Aces to another level may be perceivably noted, such as changing color, font, size, indicia, and/or other perceivable characteristics such as visible, audible, tactile, etc., as noted by Ace cards 828, 830 and 832. In the illustrated embodiment, while the Aces are at Level-2 (e.g. for 10 dealt hands, or any other desired criteria before moving upwards or downwards in level), the paytable 808B changes to reflect the evolution of the Aces to Level-2. Thus, in the illustrated example, the paytable 808B shows the pay 810 for the hand 812 of “4 Aces” 814 to now be 1500 credits 816B. Based on criteria, some embodiments allow still further levels to be reached through evolution, and to revert to an earlier level when certain criteria is not met (or other criteria is met). As can be seen, symbol evolution is applicable to poker games and other gaming activities.

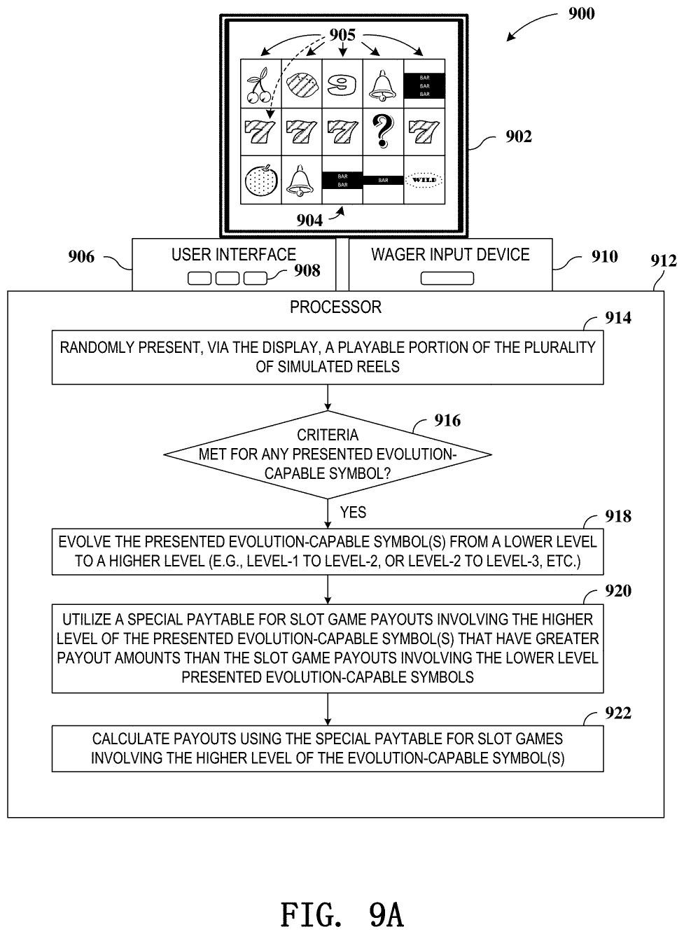

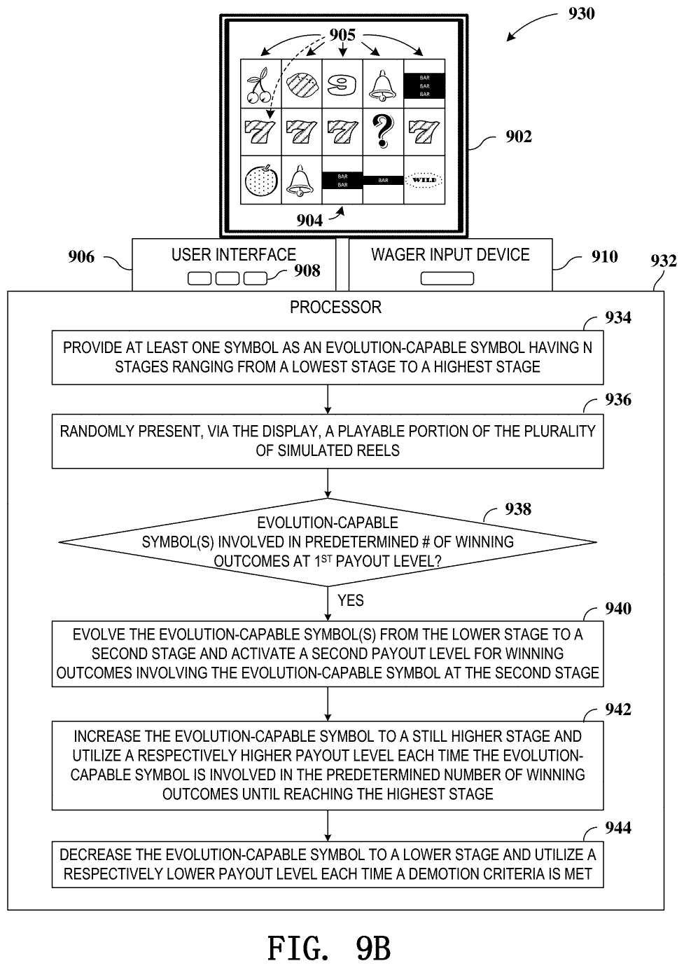

The functionality provided herein may be implemented in hardware on computing devices ranging from large gaming systems, stand-alone kiosks, to small personal devices. FIGS. 9A and 9B depict representative, illustrative slot game embodiments where a processing arrangement (which is intended to include single processors, multiple processors, or any other processing arrangement) is programmed with software, firmware, or the like to provide various modules to perform functions described herein. The principles in FIGS. 9A and 9B are equally applicable to games other than slot games, such as poker or other card games, bingo, roulette, craps, or other games where a result could be replayed in a video/electronic context or properly configured physical implementations. In the representative examples of FIGS. 9A and 9B, each of the modules represents software-programmed or otherwise designed/configured hardware to carry out functions to facilitate the gaming features described herein.

FIGS. 9A and 9B are block diagrams of representative alternative slot game apparatuses having software-programmed or otherwise designed/configured hardware for conditionally enhancing gaming payouts in accordance with the disclosure.

In the embodiment of FIG. 9A, a slot game device/apparatus 900 is provided on which players can play slot games. The representative slot game device 900 includes at least a display(s) 902 presenting a slot game symbol array or grid 904 of symbol locations or display elements, and a plurality of simulated reels 905 (which may be configured in columns, individual cells, etc.), each presentable via the display 902 and comprising a plurality of symbols from a set of available symbols. In accordance with the present disclosure, one or more of the symbols are configured as evolution-capable symbols.

The slot game device further includes a user interface 906 including at least one user input 908 to enable a player to initiate and participate in a slot game event presented via the slot game grid 904, and a wager input device 910 structured to identify and validate player assets and ultimately permit the player to play the slot game event when the player assets are provided.

The slot game device 900 includes a processor 912 configured to randomly present, 914 via the display 902, a playable portion (e.g. the array 904) of the plurality of simulated reels 905. The processor 912 is configured to determine 916 whether criteria is met for any of the one or more of the evolution-capable symbols presented on the playable portion/array 904 of the simulated reels 905. If it is determined 916 that the criteria has been met for any of the one or more presented evolution-capable symbols, the processor is configured to evolve 918 the respective ones of the presented evolution-capable symbols from a lower level to a higher level.

In one embodiment, slot game payouts involving the higher level of the respective ones of the presented evolution-capable symbols are greater than the slot game payouts involving the lower level of the respective ones of the presented evolution-capable symbols. For example, as depicted in FIG. 9A, the processor 912 may be configured to utilize 920 a special paytable for slot game payouts involving the higher level of the presented evolution-capable symbol(s) that have greater payout amounts than the slot game payouts involving the lower level presented evolution-capable symbols. The processor may be further configured to calculate 922 payouts using the special paytable for slot games involving the higher level of the evolution-capable symbol(s). From this point, these evolution-capable symbols may further rise in their respective levels based on promotion criteria, may remain the same for one or more slot games, and/or may be demoted based on demotion criteria.

In the embodiment of FIG. 9B, like reference numbers corresponding to analogous items from FIG. 9A are used. Thus, the slot game device 930 includes at least a display(s) 902 presenting a slot game symbol array or grid 904 of symbol locations or display elements, and a plurality of simulated reels 905 (which may be configured in columns, individual cells, etc.), each presentable via the display 902 and comprising a plurality of symbols from a set of available symbols where one or more of the symbols are configured as evolution-capable symbols. The slot game device further includes a user interface 906 including at least one user input 908 to enable a player to initiate and participate in a slot game event presented via the slot game grid 904, and a wager input device 910 structured to identify and validate player assets and ultimately permit the player to play the slot game event when the player assets are provided.

The slot game device 930 includes a processor 932 configured to provide 934 at least one of the symbols as an evolution-capable symbol having N stages ranging from a lowest stage to a highest stage, and to randomly present 936 a playable portion 904 of the plurality of simulated reels 905. The processor 932 of FIG. 9B is further configured to determine 938 whether the evolution-capable symbol is involved in a predetermined number of winning outcomes at a first payout level. If it is determined 938 that the evolution-capable symbol is so involved, the processor 932 is configured to evolve 940 the evolution-capable symbol from the lowest stage to a second stage, and activate a second payout level for winning outcomes involving the evolution-capable symbol at the second stage. The processor is further configured to increase 942 the evolution-capable symbol to a still higher stage and utilize a respectively higher payout level each time the evolution-capable symbol is involved in the predetermined number of winning outcomes until reaching the highest stage, and decrease 944 the evolution-capable symbol to a lower stage and utilize a respectively lower payout level each time a demotion criteria is met.

The foregoing description of the representative embodiments has been presented for the purposes of illustration and description. It is not intended to be exhaustive or to limit the invention to the precise form disclosed. Many modifications and variations are possible in light of the above teaching. For example, the present invention is equally applicable in electronic or mechanical gaming machines, and is also applicable to live table versions of gaming activities that are capable of being played in a table version (e.g., machines involving poker or card games that could be played via table games).

Some embodiments have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings. Rather, the invention is intended to cover alternatives, modifications, and equivalents that come within the scope and spirit of the inventive principles set out above.

What is claimed is:

1. A slot game apparatus for enhancing slot game awards in a slot game, comprising:
a display;
a user interface including at least one user input to enable a player to initiate and participate in the slot game;
a wager input device structured to identify and validate player assets, and to permit the player to participate in the slot game when the player assets are provided;
a plurality of simulated reels, each presentable via the display and comprising a plurality of symbols from a set of symbols, wherein one or more of the symbols are configured as evolution-capable symbols; and
a processor configured to:
randomly present, via the display, a playable portion of the plurality of simulated reels;
determine whether at least one criterium is met for any of the one or more of the evolution-capable symbols presented on the playable portion of the plurality of simulated reels; and
in response to the processor determining that the at least one criterium is met for any of the presented evolution-capable symbols, evolve the respective ones of the presented evolution-capable symbols from a lower level to a higher level, wherein slot game payouts involving the higher level of the respective ones of the presented evolution-capable symbols are greater than the slot game payouts involving the lower level of the respective ones of the presented evolution-capable symbols.

2. The slot game apparatus as in claim 1, wherein the processor is configured to determine whether the at least one criterium is met by determining that the respective presented evolution-capable symbols at their respective lower level are involved in winning outcomes resulting in the slot game payouts.

3. The slot game apparatus as in claim 1, wherein the processor is configured to provide the slot game payouts involving the higher level of the respective ones of the presented evolution-capable symbols for a consecutive number of the slot games.

4. The slot game apparatus as in claim 3, wherein the processor is configured to return the higher level evolution-capable symbols down to the lower level evolution-capable symbols and a corresponding slot game payout if the at least one criterium does not reoccur during the consecutive number of the slot games.

5. The slot game apparatus as in claim 1, wherein the processor is further configured to:
determine whether at least one additional criterium is met for any of the one or more of the higher level evolution-capable symbols presented on the playable portion of the plurality of simulated reels; and
in response to the processor determining that the at least one additional criterium is met for any of the higher level presented evolution-capable symbols, evolve the respective ones of the presented higher level evolution-capable symbols to a next higher level, wherein slot game payouts involving the next higher level of the respective ones of the presented evolution-capable symbols are greater than the slot game payouts involving the higher level of the respective ones of the presented evolution-capable symbols.

6. The slot game apparatus as in claim 5, wherein the processor is configured to provide the slot game payouts involving the next higher level of the respective ones of the presented evolution-capable symbols for a consecutive number of the slot games.

7. The slot game apparatus as in claim 6, wherein the processor is configured to return the next higher level evolution-capable symbols down to the higher level evolution-capable symbols and a corresponding slot game payout if the at least one additional criterium does not reoccur during the consecutive number of the slot games.

8. The slot game apparatus as in claim 1, wherein a plurality of the one or more of the evolution-capable symbols are provided, and at least some of the plurality of evolution-capable symbols are at different levels of evolution for a particular one of the slot games.

9. The slot game apparatus as in claim 1, wherein the processor is configured to cause the display to present different visual presentations of each of the respective levels of an evolution-capable symbol.

10. A slot game apparatus for enhancing slot game awards in a slot game, comprising:
a display;
a user interface including at least one user input to enable a player to initiate and participate in the slot game;
a wager input device structured to identify and validate player assets, and to permit the player to participate in the slot game when the player assets are provided;
a plurality of simulated reels, each presentable via the display and comprising a plurality of symbols from a set of symbols; and
a processor configured to:
provide at least one of the symbols as an evolution-capable symbol having N stages ranging from a lowest stage to a highest stage;
randomly present, via the display, a playable portion of the plurality of simulated reels;
determine whether the evolution-capable symbol is involved in a predetermined number of winning outcomes at a first payout level;
in response to determining that the evolution-capable symbol is involved in the predetermined number of winning outcomes at the first payout level, evolve the evolution-capable symbol from the lowest stage to a second stage, and activate a second payout level for winning outcomes involving the evolution-capable symbol at the second stage; and
increase the evolution-capable symbol to a still higher stage and utilize a respectively higher payout level each time the evolution-capable symbol is involved in the predetermined number of winning outcomes until reaching the highest stage, and decrease the evolution-capable symbol to a lower stage and utilize a respectively lower payout level each time a demotion criteria is met.

11. The slot game apparatus as in claim 10, wherein the processor is configured to cause the display to present a different visual appearance for each stage of the at least one evolution-capable symbol.

12. The slot game apparatus as in claim 10, wherein the predetermined number of winning outcomes is a single winning outcome.

13. The slot game apparatus as in claim 10, wherein the predetermined number of winning outcomes is greater than one.

14. The slot game apparatus as in claim 10, wherein the processor is configured to decrease the evolution-capable symbol to the lower stage and utilize the respectively lower payout level when the demotion criteria comprises the evolution-capable symbols failing to be involved in the predetermined number of winning outcomes.

15. The slot game apparatus as in claim 10, wherein the processor is configured to decrease the evolution-capable symbol to the lower stage and utilize the respectively lower payout level when the demotion criteria comprises the evolution-capable symbol existing at a current one of the stages for a predetermined number of the slot games.

16. The slot game apparatus as in claim 10, wherein the processor is configured to decrease the evolution-capable symbol to the lower stage and utilize the respectively lower payout level when the demotion criteria comprises passage of a time.

17. The slot game apparatus as in claim 10, wherein the processor is configured to decrease the evolution-capable symbol to the lower stage and utilize the respectively lower payout level when the demotion criteria relates to a number of winning outcomes within a predetermined number of the slot games.

18. The slot game apparatus as in claim 17, wherein the predetermined number of the slot games differs for each of the stages of the at least one evolution-capable symbol.

19. The slot game apparatus as in claim 10, further comprising a table of different ones of the payout levels for each of the stages of the at least one evolution-capable symbol.

20. The slot game apparatus as in claim 10, wherein the processor is configured to provide a plurality of the symbols as evolution-capable symbols, each having N stages ranging from a lowest stage to a highest stage.
